(19) United States
(12) Patent Application Publication
(10) Pub. No.: US 2006/0263170 A1
(43) Pub. Date: Nov. 23, 2006

(54) SAFETY LINE ANCHOR

(75) Inventor: Arvo POLDMAA, Hawks Nest, NSW (AU)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Arvo Poldmaa, Kathleen Poldmaa, Robyn Poldmaa and Daniel Poldmaa, Hawks Nest, NSW (AU)

(21) Appl. No.: 11/279,629

(22) Filed: Apr. 13, 2006

Related U.S. Application Data
(63) Continuation of application No. PCT/AU04/01403, filed on Oct. 14, 2004.

(30) Foreign Application Priority Data
Oct. 14, 2003 (AU) 2003905611

(51) Int. Cl. F16B 35/06

(52) U.S. Cl. 411/401

(57) ABSTRACT

A safety line anchor (10) is disclosed which includes mounting means (2) for fixing the anchor to a structure, deformation means (3) for plastically deforming on application of a high load and receiving means (12) for receiving a safety line. The deformation means is interposed between the mounting and the receiving means and is adapted to at least partially absorb some of the energy associated with the application of the high load by deforming progressively as the load is applied.

### CROSS-REFERENCE TO RELATED APPLICATIONS

This application is a continuation of International Application No. PCT/AU2004/001403, filed Oct. 14, 2004, which was published in the English language on Apr. 28, 2005, under International Publication No. WO 2005/037377 A1 and the disclosure of which is incorporated herein by reference.

### BACKGROUND OF THE INVENTION

This invention relates to a safety line anchor. More particularly, this invention relates to a safety line anchor having an energy absorbing capacity.

Safety line anchors have been described in which the line comprises a cable secured by a plurality of spaced anchors each having a cylinder to receive a section of cable and mounting means for fixing the anchor to a structure, such as a structural member of a building. Operators working in fall-risk situations are connected to the safety line by a rope connected to a shuttle adapted to run along the safety line, the other free end of the rope being connected to a safety harness worn by the operator.

The primary drawback of traditional arrangements relates to the severe jolt an operator experiences in a fall due to the absence of energy absorbing features within the arrangement. Moreover, although the safety line may itself offer some energy absorbing facility, the elastic nature of such energy absorption has its own hazards in that the safety line tends to elastically rebound placing the operator in further danger.

### BRIEF SUMMARY OF THE INVENTION

Accordingly, there is a need for an improved safety line anchor or at least an arrangement which provides a useful alternative to existing systems.

Accordingly, the invention provides in one embodiment a safety line anchor including:

a) mounting means for fixing the anchor to a structure;

b) deformation means for plastically deforming on application of a high load; and

c) receiving means for receiving a safety line,

wherein the deformation means is interposed between the mounting and the receiving means and is adapted to at least partially absorb some of the energy associated with the application of the high load by deforming progressively as the load is applied (ie in a prescribed manner).

The safety line may be made from a variety of materials and consist of a wide range of configurations. For example the safety line may be a synthetic or natural fibred rope, metal cable or a rigid metal rod (eg in the form of a rail). The safety line may be installed in a wide variety of locations. For example, the safety line anchor may be mounted on a wall, such as an external wall, ceiling, floor or roof or on other structures where workers are required to work at heights from which there is the potential to fall.

The mounting means may include a wide range of mounting fixtures well known to persons skilled in the art. The mounting means may include brackets bolted, screwed, otherwise fastened, or alternatively welded to the structure. The anchor may include only part of the mounting means, such as a portion adapted to engage with a complimentary portion mountable to the structure. For example, the anchor may be in the form of an anchor bolt having a threaded lower bolt portion adapted to engage with a correspondingly threaded bore in a mount fixed to or part of the structure.

The deformation means may include a number of features capable of absorbing the kinetic energy associated with a fall occasioning the application of a high load to the anchor. For example, the deformation means may include one or more features adapted to bend plastically upon application of the high load and accordingly, the deformation means may comprise one or more components of the anchor.

Preferably the deformation means includes a shaft or rod extending from the mounting means to the receiving means. The rod may be hollow or solid. The rod is preferably tapered. Preferably the tapering is such that the rod is wider at its base adjacent the mounting means and tapers towards its upper end. Preferably the deformation will occur progressively along the length of the shaft or rod starting from below the receiving means for the safety line and moving towards the mounting means. In this way the initial load on the structure is minimised, so that by the time the force reaches the mounting means it has been significantly reduced, thereby resulting in less damage to the structure and/or any roofing material etc associated therewith. Furthermore, the deformation thus caused is visible and serves as an indication that the safety line anchor assembly should be replaced, having been thus used.

In an alternative arrangement, the deformation means includes a combination of components which comprise a first formation prior to application of the high load and a second different formation subsequent to application of the high load, such that considerably energy is required to shift the deformation means from the first formation to the second formation. However, the deformation means is returnable to the first formation from the second formation. An example of this arrangement includes an array of struts joined to each other by tightly fitted joints whereby the various components are pivotable relative to one another but the relative movement involves substantial friction thereby absorbing energy.

The receiving means may include a pipe. The pipe preferably is cylindrical. The pipe is preferably elongate. The external surface of the pipe is preferably only slightly greater in diameter than the safety line to facilitate easy passage of a shuttle over the receiving means.

The receiving means may include at least one protrusion extending from at least one end of the pipe. The protrusion may be in the form of a tube. The tube may protrude from at least one end of the pipe. The tube may protrude from both ends of the pipe. The protrusion may be adapted to engage with a connecting section which in turn is adapted to act as a bridge to an adjacent like anchor. The bridge may operate as a corner section. The bridge may be in the form of a sleeve. For example, the external diameter of the sleeve may be similar to that of the pipe whereby the shuttle may pass around a corner by riding over a first anchor, then over the sleeve followed by a second adjacent anchor oriented in a different direction.

The receiving means may also be deformable on application of the high load. The tube may in preference to the pipe be deformable on application of the high load. Once the tube has deformed, the pipe may subsequently also deform, thereby providing further capacity for the anchor to absorb the energy of a fallen worker.

The receiving means may be supported on the deformation means by a support. The support may include a variety of configurations suitable for the purpose. The support may include one or more connecting rods or bars. The support may be a plate. The deformation means may have a longitudinal axis and the plate may lie in a single plane whereby the longitudinal axis of the deformation means lies in the plane of the plate.

Alternatively, the plate may be non-planar or may lie in a plane such that the longitudinal axis does not lie in that plane. For example, the plate may be curved or angular. Preferably, however, the plate is planar and the longitudinal axis of the deformation means lies in the plane.

The plate may include free edges. The edges may extend between the receiving means and the deformation means. The edges may diverge from the deformation means to the receiving means whereby to form a truncated triangle. The plate may be of a constant thickness or may vary such that various regions of the plate are thicker than other regions. The thinner regions of the plate may preferentially deform thereby providing a further feature of the anchor which can deform and absorb energy. If the thickness of the plate does vary, preferably its lower portions are thicker than its upper portion, the decrease in thickness being preferably graded. Preferably, however, the plate has a constant thickness and is of rigid constructions.

The plate may be adapted to facilitate the torsional twisting of the deformation means upon the application of high load. The torsional twisting of the deformation means may further assist to absorb energy. Where the edges of the plate diverge and the plate has the form of a truncated triangle having a narrow base and wide upper section, this configuration assists in providing leverage for the safety line through the receiving means to apply torsional forces or moment to the deformation means about the longitudinal axis.

The anchor may be integrally formed. Alternatively, the various components of the anchor may be separately formed and subsequently assembled together by a standard means such as welding, lockable and/or threaded coupling and the like. Preferably, however, the anchor is integrally formed by forging. The anchor may include a range of materials suitable for the purpose. However, preferably the anchor is formed from stainless steel, preferably forged.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a side elevation of an anchor bolt according to one embodiment; and

FIG. 2 is a second side elevation of the anchor bolt of the embodiment shown in FIG. 1 rotated 90°.

### DETAILED DESCRIPTION OF THE INVENTION

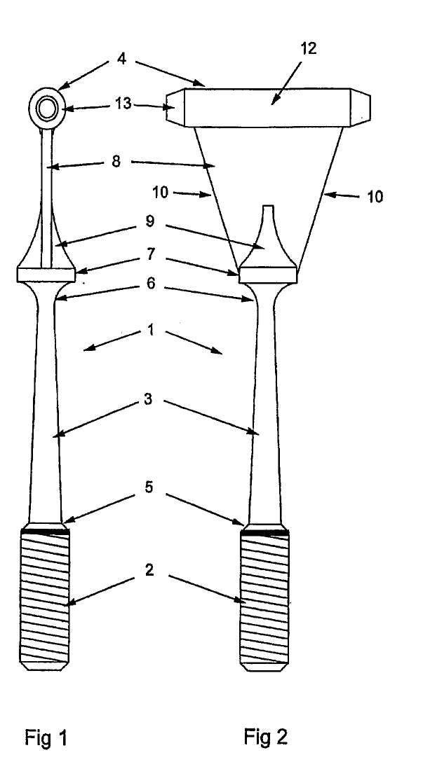

In FIG. 1 there is shown an anchor bolt 1 in the form of an eyebolt including a lower threaded bolt portion 2, a tapered intermediate shaft 3 and receiving means 4. The eyebolt is manufactured by forging 316 stainless steel as an integral whole.

The threaded portion 2 is adapted to couple with a complimentarily threaded mounting bracket (not shown) which includes a corresponding threaded bore. The threaded portion 2 is standardised 16 mm thread having a shaft of 50 mm in length. The join to the tapered shaft 3 is bevelled at location 5 to provide a gradual transition from the diameter of the 16 mm thread to the narrower 14 mm base diameter of the tapered shaft 3.

The tapered shaft 3 has a circular cross section throughout its length and tapers up to a narrowest diameter of 9.5 mm at its neck 6, above which the shaft 3 diverges to meet a base of a support 7 for a plate 8 which connects the receiving means 4 to the shaft 3.

As seen with reference to FIG. 2, the support base 7 includes a plate transverse to the longitudinal axis of the shaft 3 on which rests the plate 8 extending upwardly, its plane being in line with the longitudinal axis of shaft 3. The plate 8 is reinforced to resist lateral movement by a pair of side struts 9 extending from the support base 7 and tapering to a region intermediate either side wall surface of the plate 8. The plate 8 is of a truncated triangular configuration whereby it is narrower at its base and includes upwardly diverging free edge walls 10 which extend up to and engage with the receiving means 4.

The receiving means 4 is either in the form of a pipe 12 made from a pair of coaxial tubes (ie a tube within a pipe not specifically shown) or may be formed from an integral thicker tube depending on the application as described herein. The receiving means 4 thus forms a pipe 12 extending transverse to the longitudinal axis of the shaft 3, having in the embodiment shown, tapered end regions 13. The pipe 12 is adapted to receive a length of safety line being in the form of a stainless steel rope.

The ends of the tube 12 are preferably bevelled as shown in FIG. 2 at item 13 or otherwise inclined whereby to provide a ramp to facilitate the smooth running of a shuttle (not shown) running thereover.

Where the tube 12 is actually formed from a pair of coaxial tubes a step can be provided by having the internal tube extend beyond the external tube so that in combination the difference in diameter provides the step therebetween. The stepped relationship thus provides engagement means for coupling a sleeve (not shown) having complementary transverse dimensions and adapted to join adjacent anchor bolts 1 at, for example corner sections, to provide for a smooth running of the shuttle through a section of safety line which changes direction due to the orientation of adjacent anchor bolts 1.

In operation, the installed anchor bolt 1 remains rigid and undeformed during normal operations of a worker connected to the safety line. However, should the worker fall thereby applying a high concentrated load to the safety line, and in turn, the anchor bolt 1, the worker's kinetic energy will be absorbed initially by the plastic deformation of the tapered shaft 3, beginning at neck 6. Further progressive deformation of the anchor bolt 1 is possible in that the leveragable configuration of the receiving means 4 and plate configuration 8, applies moment to the shaft 3, particularly at the neck 6. Further energy absorption may occur by the deformation of pipe 12 itself.

The plastic deformation feature of the anchor bolt 1 assists in gradually slowing the descent of the fallen worker and retards any tendency of the arrangement to elastically rebound which would otherwise increase the hazards associated with the fall. Upon deformation of the anchor bolt 1, the use of the anchor bolt 1 is exhausted and must be replaced.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A safety line anchor including:
a) mounting means for fixing the anchor to a structure;
b) deformation means for plastically deforming on application of a high load;
c) receiving means in the form of a pipe for receiving a safety line,
wherein the deformation means is interposed between the mounting and the receiving means and is adapted to at least partially absorb some of the energy associated with the application of the high load by deforming progressively as the load is applied.

2. The anchor according to claim 1, wherein the receiving means includes at least one tube within the pipe.

3. The anchor according to claim 2, wherein the tube protrudes from at least one end of the pipe.

4. The anchor according to claim 2 wherein the tube protrudes from both ends of the pipe.

5. The anchor according to claim 4, wherein the tube is adapted to engage with a connecting sleeve which in turn is adapted to act as a bridge to an adjacent like anchor.

6. The anchor according to claim 5, wherein the bridge operates as a corner section.

7. The anchor according to claim 1, wherein the receiving means is deformable on application of the high load.

8. The anchor according to claim 2, wherein the tube in preference to the pipe is deformable on application of the high load.

9. The anchor according to claim 1, wherein the receiving means is supported on the deformation means by a plate.

10. The anchor according to claim 9, wherein the deformation means has a longitudinal axis and the plate lies in a plane and that longitudinal axis lies in that plane.

11. The anchor according to claim 9, wherein the edges of the plate extending from the deformation means to the receiving means diverge.

12. The anchor according to claim 11, wherein the plate is adapted to facilitate the torsional twisting of the deformation means upon the application of the high load.

13. The anchor according to claim 1, wherein the deformation means is a tapered rod which is wider at its base close to the mounting means and narrower at a neck proximal to its top end.

14. The anchor according to claim 1, wherein the mounting means is a threaded bolt section at the base of the anchor.

15. The anchor according to claim 1, wherein the anchor is integrally formed.

16. The anchor according to claim 15, wherein the anchor is manufactured by forging.
